(19) United States
(12) Patent Application Publication
(10) Pub. No.: US 2008/0031219 A1
(43) Pub. Date: Feb. 7, 2008

(54) ACCESSING AN ACCESS NETWORK TO ENABLE GRADE OF SERVICE IN CALLS OR FLOW REQUESTS FOR TARGET USERS OF ACCESS TERMINALS

(75) Inventor: Jialin Zou, Randolph, NJ (US)

Correspondence Address: WILLIAMS, MORGAN & AMERSON, 10333 RICHMOND, SUITE 1100, HOUSTON, TX, 77042, US

(73) Assignee: LUCENT TECHNOLOGIES, INC.

(21) Appl. No.: 11/461,671

(22) Filed: Aug. 1, 2006

(51) Int. Cl. H04B 7/212

(52) U.S. Cl. 370/348; 370/444

(57) ABSTRACT

A method and an apparatus are provided for accessing an access network to call at least one target access terminal on a wireless network. The method includes associating an indication of priority with a call for a caller at a source access terminal that initiates the call. The method further includes sending the indication of priority to a first portion of the access network for providing an indication of priority grant at the at least one target access terminal for the call. For example, a call flow to a target access terminal may be controlled in an Internet Protocol (IP)-based network of first and second portions of an access network by using a message including a call priority associated with an incoming call at the first portion of the access network coupled to a call initiating access terminal. The second portion of the access network may grant substantially the same call priority of the incoming call. To access the access network for a call initiating user, an access terminal may determine whether a new priority granted to the access terminal is different than an original priority. If so, the access terminal reconfigures based on the new priority granted to perform at least one of a hashing, access, and connection request procedures based on the granted new priority.

### BACKGROUND OF THE INVENTION

1. Field of the Invention

This invention relates generally to communication systems, and, more particularly, to wireless communication systems.

2. Description of the Related Art

A conventional wireless communication system provides wireless connectivity to numerous access terminals (ATs) such as the cellular telephones, personal data assistants, smart phones, pagers, text messaging devices, global positioning devices, notebook computers, desktop computers, and the like. A single access terminal may, however, be capable of running numerous applications including a voice application. For example, a Push-to-Talk application may allow a single access terminal to establish a voice call with numerous other access terminals.

To provide wireless connectivity to access terminals, many conventional wireless communication systems include one or more access networks (ANs), which may also be referred to as node-Bs, base stations, and base station routers. For example, access networks in the wireless communication system may provide wireless connectivity to access terminals located in geographical areas, or cells, associated with the access networks.

By accessing an access network, an access terminal may establish a call session with other access terminals on the reverse link and the forward link. When an access terminal attempts to initiate a call session with an access network, the access network determines whether or not to admit the call based in part on the radio resource budget. For example, the access network may execute a Call Admission algorithm to determine whether or not a request to establish a call session can be accepted. If the request is accepted a new call session may be established between the access terminal and the access network. If not, then the call is blocked and is given a call denial treatment. For example, a call session request may be denied when there are insufficient network resources to maintain the new call without causing another existing call to drop or increasing the probability that an existing call may be dropped above a predetermined level.

To initiate a call session, an idle access terminal transmits a call request (or connection request) to one or more access networks to provide wireless connectivity to the cell that includes the access terminal. If the access network has sufficient capacity to support a new call, then the access network may transmit a message granting the access terminal's call request. The requested call session may be initiated and the access terminal may enter the active state. However, not all call requests are granted.

A call request from an access terminal may be denied because the system is overloaded and lacks sufficient capacity to support a new call. For example, the access network may not have sufficient radio frequency resources to support an air interface between the access network and the access terminal and may therefore deny the request. In other situations, there may not be sufficient backhaul capacity to support an additional call in the wireless communication system. In yet other situations, the processor occupancy associated with processors in the base station or access network may be too high to support an additional call.

To this end, increasingly many applications to be supported rely on Grade of Service (GoS) features. For example, in the private sector different custom applications may offer premium driven priority services or special family focused programs. Likewise, supporting the business sector and public sector applications involves adequately handling emergency calls, priority calls (in both business and public sectors), providing police patrolling support, fire worker emergency support, a privileged level support for business leaders and commanders and enabling group communication activities.

Some of the requirements associated with such applications include supporting different levels of priorities for access and admission, reflecting different levels of priorities in an overload control condition, and factoring GoS for different priorities in resource allocation decisions. Additionally, in case of some other applications, the inherent nature of the applications may cause the quality of service requirements to be insufficient in meeting a desired level of an end-to-end service. Examples of these applications include interactive delay sensitive applications including Push to Talk (PoT) or media applications, applications involving group activities based on broadcast or multicast messaging and applications sensitive to power savings.

However, conventional call admission algorithms implemented in packet-based networks consider the quality of service (QoS) requirements associated with each access terminal that has an active call session. For example, the call admission algorithm may determine a traffic load associated with each access terminal for each access terminal. Such call admission algorithms may also determine the traffic load associated with each access terminal using an assumed (or default) average data rate in the access terminal. However, the service of one or more calls could fail to meet the committed quality of service requirements and in some cases an active call could be dropped or a priority call may not be admitted.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for accessing an access network to call at least one user associated with at least one target access terminal on a wireless network. The method includes associating an indication of priority to a call for a caller at a source access terminal that initiates the call. The method further includes sending the indication of priority to a first portion of the access network for providing an indication of priority grant at the at least one target access terminal for the call.

In another embodiment of the present invention, a method is provided for controlling a call flow from a call initiating access terminal to a target access terminal in an Internet Protocol (IP)-based network of first and second portions of an access network. The method includes receiving a message including a call priority associated with an incoming call at the first portion of the access network coupled to the call initiating access terminal. The method further includes enabling the second portion of the access network coupled to the target access terminal to grant a priority indication substantially the same as the call priority of the incoming call.

In yet another embodiment of the present invention, a method is provided for accessing an access network for a call initiating user at an access terminal in an Internet Protocol (IP)-based network. The method comprises, in response to determining granting of a new priority to the access terminal different than an original priority associated with the access terminal, reconfiguring the access terminal based on the new priority granted to configure the access terminal to perform at least one of a hashing, access, and connection request procedures based on the granted new priority.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates one exemplary embodiment of a wireless communication system including a plurality of access terminals and first and second portions of an access network, in accordance with the present invention;

FIG. 2 conceptually illustrates one exemplary embodiment of a method of accessing the access network shown in FIG. 1 to call at least one user associated with at least one target access terminal on a wireless network, according to the present invention;

FIG. 3 conceptually illustrates one exemplary embodiment of a method of controlling a call flow from a call initiating access terminal to a target access terminal in an Internet Protocol (IP)-based network of the first and second portions of the access network, consistent with the present invention;

FIG. 4 conceptually illustrates one exemplary embodiment of a method of using a priority level for an incoming call to support an end-to-end service based on a desired Grade of Service (GoS) with an associated Quality of Service for at least one user of the target access terminal by granting substantially the same priority of a call initiator to the incoming call, in accordance with the present invention; and

FIG. 5 conceptually illustrates one exemplary embodiment of a method of accessing the access network for the call initiating user at an access terminal in the Internet Protocol (IP)-based network to support the desired Grade of Service (GoS), in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Generally, a method and an apparatus are provided for accessing an access network to call at least one user associated with at least one target access terminal on a wireless network. The method includes associating an indication of priority to a call for a caller at a source access terminal that initiates the call. The method further includes sending the indication of priority to a first portion of the access network for providing an indication of priority grant with substantially the same the priority at the at least one target access terminal for the call. For example, a call flow to a target access terminal may be controlled in an Internet Protocol (IP)-based network of first and second portions of an access network by using a message including a call priority associated with an incoming call at the first portion of the access network coupled to a call initiating access terminal. The second portion of the access network may grant substantially the same call priority of the incoming call. To access the access network for a call initiating user, an access terminal may determine whether a new priority granted to the access terminal is different than an original priority. If so, the access terminal reconfigures based on the new priority granted to perform at least one of a hashing, access, and connection request procedures based on the granted new priority.

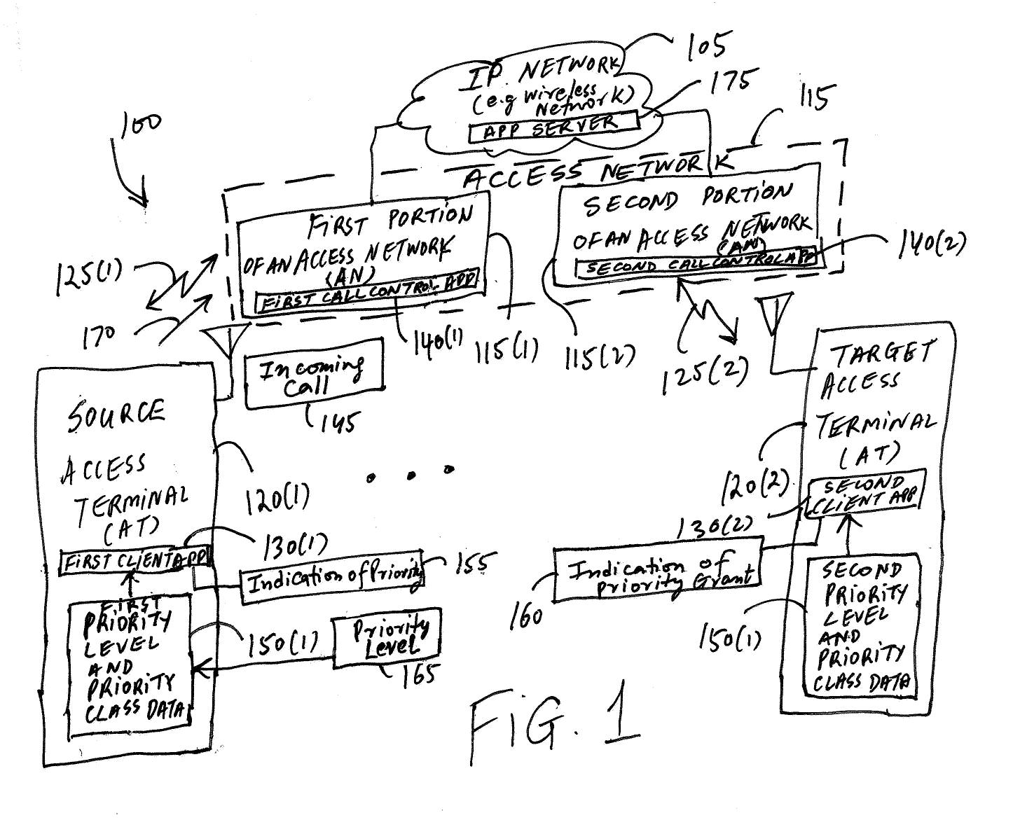

FIG. 1 conceptually illustrates one exemplary embodiment of a wireless communication system 100. In the illustrated embodiment, the wireless communication system 100 operates according to one or more air interface standards and/or protocols, such as the CDMA2000 Evolution-Data Optimized (EVDO) and Universal Mobile Telecommunication Services (UMTS) standards defined by the Third Generation Partnership Project (3GPP2, 3GPP). However, persons of ordinary skill in the art should appreciate that the present invention is not limited to a wireless communication system 100 that operates according to these particular standards and/or protocols. In alternative embodiments, the wireless communication system 100 may operate according to any wired and/or wireless standard and/or protocol. The wireless communication system 100 also includes a network 105 that may operate according to an Internet Protocol (IP), as well as one or more of the standards and/or protocols described above. For example, the network 105 may be a public Internet and/or a private Intranet coupled to one or more core networks of a wireless network, such as a digital cellular network.

The network 105 may be communicatively coupled to an access network (AN) 115 comprising first and second portions 115(1,2) of the access network 115. For example, a standard CDMA2000 EVDO network environment includes one or more Gateway General Packet Radio Service (GPRS) Support Nodes (GGSNs), Serving GPRS Support Nodes (SGSNs), Radio Network Controllers (RNCs) and Node-Bs. The GGSNs and SGSNs are typically considered part of the wireless network. The RNC and the Node-Bs typically form the access network 115, which may also be referred to as a Radio Access Network (RAN). The GGSN, SGSN and portions of the RNC may provide IP tunneling functionality and macro-mobility. The RNCs and Node-Bs may provide for wireless transmission and reception functionality and micro-mobility functionality. However, persons of ordinary skill in the art should appreciate that the present invention is not limited to embodiments that include an access network 115. In other embodiments, wireless connectivity may be provided by other devices such as base stations, base station routers, and the like.

In operation, the access network 115 provides wireless connectivity to one or more access terminals (ATs) 120(1,2). Examples of the access terminals 120(1,2) may include laptop computers, smart phones, and mobile phones, as well as other devices not shown in FIG. 1 such as personal data assistants, desktop computers, paging devices, network interface cards, and the like. Persons of ordinary skill in the art having benefit of the present disclosure should appreciate that the access terminals 120 may also be referred to using other terms such as “mobile units,” “user terminals,” “user equipment,” “mobile terminals,” and the like.

According to one exemplary illustrated embodiment of the present invention, a source access terminal 120(1) and a target access terminal 120(2) may establish communication links to the access network 115 over air interfaces 125(1,2), respectively, which may support one or more traffic, data, and/or signaling channels over a forward link (or downlink) and/or a reverse link (or uplink). However, persons of ordinary skill in the art should appreciate that the present invention is not limited to two access terminals 120(1,2) or two air interfaces 125. For example, the number of access terminals 120 in communication with the access network 115 may vary over time. The source and target access terminals 120(1,2) may transmit and/or receive voice information over the air interfaces 125(1,2).

Consistent with one embodiment of the present invention, the source access terminal 120(1) may implement a first client application (APP) 130(1), such as a calling application using Voice over IP (VoIP) for transmitting and/or receiving voice information over the air interface 125(1). Likewise, the target access terminal 120(2) may implement a second client application (APP) 130(2), such as a wireless telephone application for transmitting and/or receiving voice information over the air interface 125(2).

In one exemplary embodiment, the first portion of the access network 115(1) may include a first call control application (APP) 140(1) that may be used to control a call flow of an incoming call 145 by transmitting and/or receiving voice information for a caller at the source access terminal 120(1), which may be a call initiating access terminal (AT). Likewise, in the illustrated embodiment, the second portion of the access network 115(2) may include a second call control application (APP) 140(2) that may be used to transmit and/or receive voice information. Exemplary first and second call control applications 140(1,2) include, but are not limited to, applications for establishing two-way full-duplex voice calls and/or two-way half-duplex voice calls, a Push-to-Talk call application, a VoIP call application, a three-way call application, a chat room application, a conference bridge call application, and the like.

Each of the first and second call control applications 140(1,2) may provide one or more services at different grades, i.e., a desired Grade of Service (GoS) each of which may have different associated Quality of Service (QoS) information. Both the Grade of Service (GoS) and Quality of Service (QoS) information may therefore be associated with each of the call control applications 140, as well as the call flows and/or users associated with voice or multimedia applications. However, based on a specific implementation or application, one or more of call control applications 140 may be used to support one or more call flows associated with one or more users of the source access terminal 120(1).

As shown in the illustrated embodiment of FIG. 1, for use by the first client application 130(1) and the first call control application 140(1), first priority level and priority class data 150(1) associated with the call flows, and/or the users may be defined and stored in the source access terminal 120(1). For example, the source access terminal 120(1) may include one or more memory elements for storing the first priority level and priority class data 150(1). Likewise, the second client application 130(2) may store second priority level and priority class data 150(2) at the target access terminal 120(2).

Consistent with one embodiment of the present invention, the first priority level and priority class data 150(1) may define one or more priority levels based on a type of the call 145 or a flow request for providing a priority access and call admission to the call 145 in the access network 115. Additionally or alternatively, the first priority level and priority class data 150(1) may define one or more priority classes for one or more priority levels to support a desired Grade of Service (GoS) with a Quality of Service (QoS). Accordingly, the first client application 130(1) may enable use of different power ramps and back-off functions with different initial and ending access probe power level corresponding to a different priority level or class of the priority levels and classes.

For calling at least one user associated with at least one targeted access terminal, such as the target access terminal 120(2) on a wireless network, the first client application 130(1) may access the first priority level and priority class data 150(1) to provide access to the access network 115. By using the first priority level and priority class data 150(1), the first client application 130(1) may associate an indication of priority 155 to the call 145 for a caller, such as a call initiator at the source access terminal 120(1) that initiates the call flow. The source access terminal 120(1) may send the indication of priority 155 to the first portion of the access network 115(1) for providing an indication of priority grant 160 with substantially the same priority, i.e., a priority level 165 at the target access terminal 120(2) for the call 145. In this way, call priority level and priority class information to support the desired Grade of Service (GoS) based on the indication of priority 155 may be communicated by the first client application 130(1) to the first call control application 140(1) of the first portion of the access network 115(1). Alternatively, the indication of priority grant 160 with substantially the same priority level 165 may enable a desired Grade of Service for a group of users associated with the target access terminal 120(2) by granting substantially the same priority of the caller to the call 145.

The source access terminal 120(1) may provide a call session request to the first portion of the access network 115(1), as indicated by the arrow 170. For example, a user of the source access terminal 120(1) may initiate a call session to establish voice communication with a user of another access terminal, the target access terminal 120(2) that is communicatively coupled to the second portion of the access network 115(2). The call session request may be provided by the first client application 130(1), e.g., a calling application implemented on the source access terminal 120(1). As used herein, the term “calling application” refers to hardware, firmware, software, or a combination thereof that is used to implement a particular technique for accessing the wireless communication system 100 so that voice information be transmitted to and/or received from the wireless communication system 100. Exemplary calling applications include, but are not limited to, cellular telephone applications for implementing two-way full-duplex voice calls and/or two-way half-duplex voice calls, as well as Push-to-Talk applications, VoIP applications, a three-way calling applications, a chat room application, a conference bridge call application, and the like. Persons of ordinary skill in the art having benefit of the present disclosure should appreciate other media including multimedia information indicative of data and/or video may be associated by or for a user of the source access terminal 120(1).

For the first portion of the access network 115(1) to admit the requested call session, the first client application 130(1) may associate Quality of Service (QoS) information with a Grade of Service (GoS) provided by the calling application and/or the wireless communication system 100 for call flows and/or users associated with the calling application. Examples of Grade of Service (GoS) provided by the calling application may provide “Premium,” “Basic,” and “Budget” grades of service. As used herein, the phrase “Quality of Service (QoS) information” will be understood to refer to information indicative of some aspect of the Quality of Service (QoS) that may be associated with the requested call session. In one embodiment, the Quality of Service (QoS) information may indicate a call activity factor and an average data rate used by the calling application.

In one embodiment, the network 105, such as an Internet Protocol (IP)-based network may use an application (APP) server 175 to pass the indication of priority 155 to the second portion of the access network 115(2) for further paging the indication of priority grant 160 of the priority level 165 to the target access terminal 120(2) by the second portion of the access network 115(2). In this way, the network 105 may enable a desired Grade of Service for a user associated with the target access terminal 120(2) by granting substantially the same priority of a call initiator to the incoming call 145. Moreover, the first portion of the access network 115(1) may control an admission control parameter, an overload control parameter and/or a resource allocation parameter based on the indication of priority 155 at the source access terminal 120(1) to meet a desired Grade of Service for the call initiator to the incoming call 145.

In one embodiment, the first portion of the access network 115(1) may send a multicast message to indicate an alert mode to a group of users at an associated set of access terminals which are currently in a normal mode that indicates an idle state. In response to the multicast message, the access network 115 may enable waking-up of the associated set of access terminals more often than in a non-alert mode, sending of a message for a route update more often, and/or boosting a level of pilot power to another level. By defining one or more priority levels based on a type of at least one of call or flow, a priority access and call admission may be provided to the call 145 in the access network 115. Likewise, one or more priority classes may be defined for the priority levels to support a desired Grade of Service (GoS) with a Quality of Service (QoS). In this way, different power ramps and back-off functions may be used with different initial and ending access probe power level corresponding to a different priority level or class of the defined priority levels and classes.

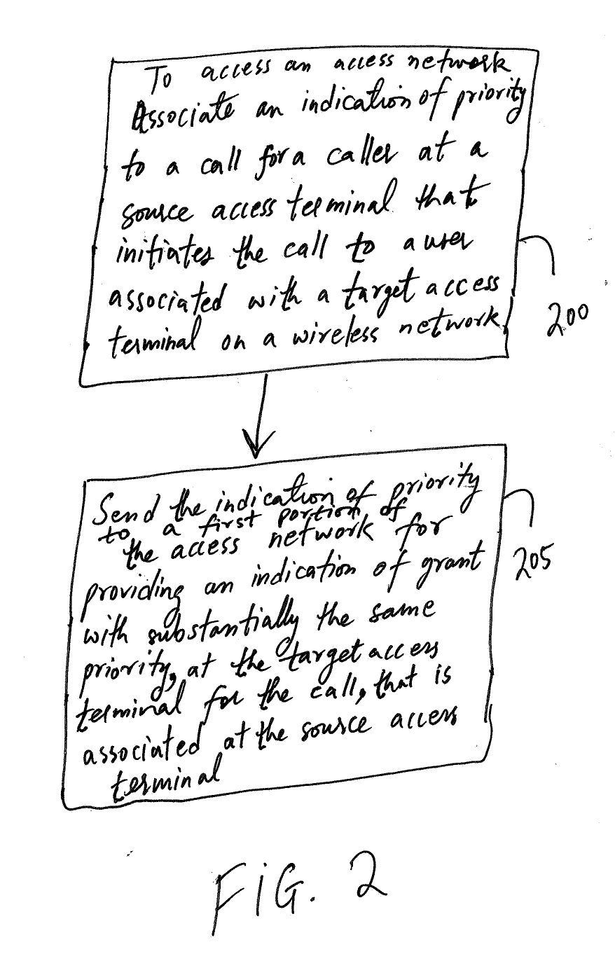

FIG. 2 conceptually illustrates one exemplary embodiment of a method of accessing the access network 115 shown in FIG. 1 to call at least one user associated with the target access terminal 120(2) on a wireless network, according to the present invention. At block 200, the first client application 130(1) may access the first portion of the access network 115(1) to call at least one user associated with at least one access terminal 120, such as the target access terminal 120(2) on a wireless network. For example, in a High Rate Packet Data (HRPD) (IS-856) wireless network, the first client application 130(1) may associate the indication of priority 155 to the call 145 for a caller at the source access terminal 120(1) that initiates the call. The indication of priority 155 may specify a desired Grade of Service (GoS) associated with the calling application, the call flow, and/or the user to the first call control application 140(1) at the first portion of the access network 115(1).

Consistent with one embodiment of the present invention, the source access terminal 120(1) may issue a request message, such as a connection request message and/or an application flow reservation request message with the indication of priority 155 for the call 145 on the air interface 125(1) link to the first portion of said access network 115(1). The source access terminal 120(1) may send the indication of priority 155 to the first portion of the access network 115(1) for providing the indication of priority grant 160 with substantially the same priority level 165 at the target access terminal 120(2) for that call 145, as indicated in block 205. For example, a user may invoke the first client application 130(1) to establish a call session with the first portion of the access network 115(1). The first client application 130(1) may access the first priority level and priority call data 150(1) to determine the priority level 165 associated with the call 145 and may then provide information indicative of a call priority and/or class as a part of the request message.

To support an end-to-end service based on a desired Grade of Service (GoS) with an associated Quality of Service (QoS) for the user of the target access terminal 120(2), the first portion of the access network 115(1) may receive the priority level 165 for the incoming call 145 or a flow request. For example, the first portion of the access network 115(1) may receive a call priority associated with the incoming call 145 in a message, such as a connection request (CR) message and/or an application flow reservation request message.

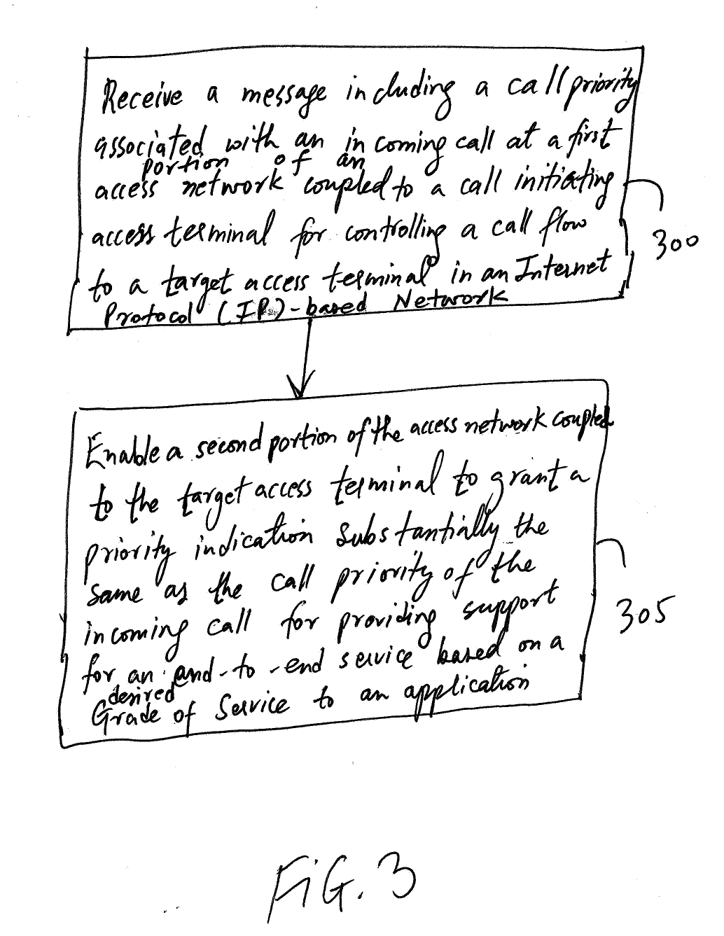

FIG. 3 conceptually illustrates one exemplary embodiment of a method of controlling a call flow from a call initiating access terminal, i.e., the source access terminal 120(1) to the target access terminal 120(2) in the Internet Protocol (IP)-based network 105 coupled to the first and second portions of the access network 115(1,2), consistent with the present invention. As illustrated in block 300, the first portion of the access network 115(1) coupled to the source access terminal 120(1) may receive a message including a call priority, such as the priority level 165 associated with the incoming call 145. In the illustrated embodiment, the message may include information indicative of Grade of Service (GoS) and/or Quality of Service (QoS) information associated with the first client application 130(1). That is, by using the indication of priority 155, the first call control application 140(1) may decide whether to allow or block the requested call 145 based on a desired Grade of Service (GoS) and/or Quality of Service (QoS) on a forward link and/or a reverse link.

In particular, to control the call flow, the first call control application 140(1) may implement a call admission algorithm to determine whether or not to admit the call 145 at the first portion of the access network 115(1). For example, the first call control application 140(1) may determine whether or not to admit the call 145 requested by the source access terminal 120(1) based on the Grade of Service (GoS) and/or Quality of Service (QoS) information indicated by the priority level 165. Persons of ordinary skill in the art having benefit of the present disclosure should appreciate that the call admission algorithm may be implemented in hardware, firmware, software, or any combination thereof. For example, the call admission algorithm may be implemented in software that may be executed by a processor (not shown) included in the access network 115.

At block 305, the second portion of the access network 115(2) may grant the call priority to the target access terminal 120(2). In other words, the IP-based network 105 may enable the second portion of the access network 115(2) coupled to the target access terminal 120(2) to grant the priority level 165 within the indication of priority grant 160 as substantially the same call priority of the incoming call 145. This granting of the call priority may support an end-to-end service based on a desired Grade of Service (GoS) with an associated Quality of Service (QoS) for the user of the target access terminal 120(2) since granting of the call priority to the target access terminal 120(2) may cause it to configure based on a granted priority having substantially the same call priority of the incoming call 145.

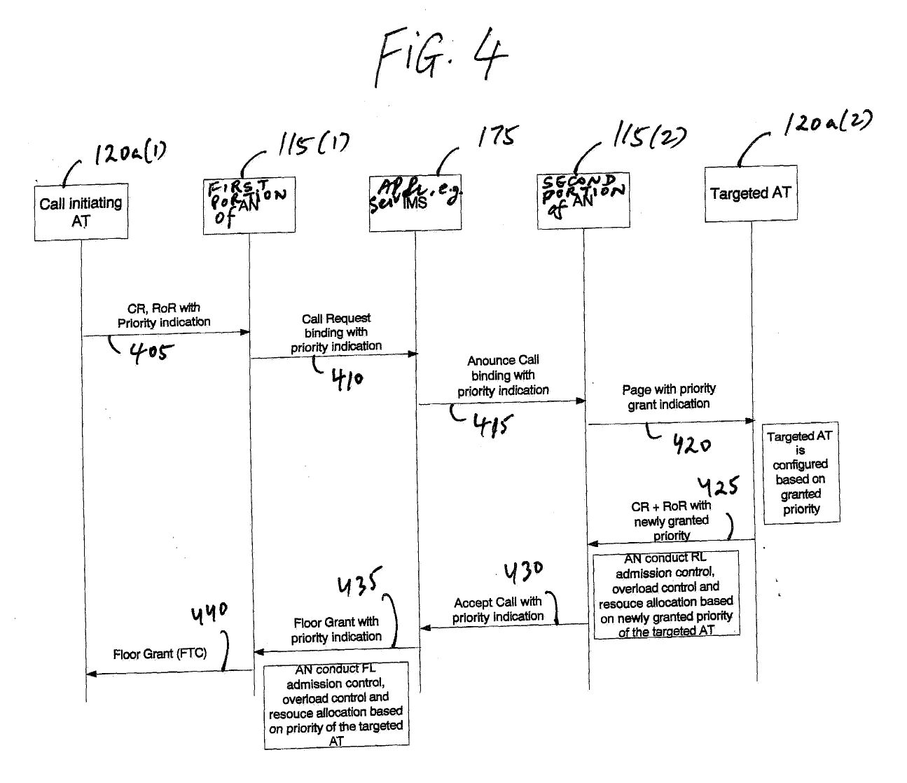

FIG. 4 conceptually illustrates one exemplary embodiment of a method of using the priority level 165 for the incoming call 145 to support an end-to-end service based on a desired Grade of Service (GoS) with an associated Quality of Service (QoS) for the user of the target access terminal 120(2), in accordance with the present invention. In the illustrated embodiment, the target access terminal 120(2) may be granted substantially the same priority of a call initiator to the incoming call 145.

As illustrated by the arrow 405, a connection request (CR) and/or a reservation on request (RoR) with the indication of priority 155 is provided by a call initiating access terminal 120a(1) to the first portion of the access network 115(1). The reservation on request essentially provides an application flow reservation request. The first portion of the access network 115(1) then binds such a request for initiating the call 145 with the indication of priority 155 associated with the call 145 at the call initiating access terminal 120a(1), as shown by the arrow 410. For example, this request may cause the application server 175, e.g., an Information Management System (IMS) server associated with a call network to announce binding of the request for initiating the call 145 with the indication of priority 155 to the second portion of the access network 115(2) coupled to a targeted access terminal 120a(2), as depicted by the arrow 415.

The arrow 420 shows paging of the targeted access terminal 120a(2) with the indication of priority grant 160 by the second portion of the access network 115(2) in response to the binding of the request for initiating the call 145. For the purposes of completing the call, the paging may indicate granting a call priority to the targeted access terminal 120a(2) based on the indication of priority grant 160. This granting of the call priority may cause the targeted access terminal 120a(2) to configure based on a granted priority having substantially the same priority level 165 of the call at the call initiating access terminal 120a(1). The targeted access terminal 120a(2) may issue a connection request (CR) message and/or an application flow reservation request message with the newly granted priority to the second portion of the access network 115(2), as illustrated by the arrow 425.

The CR and/or RoR messages may enable the second portion of the access network 115(2) to admit the call 145, provide an overload control and/or allocate a resource based on the granted priority level 165 of the targeted access terminal 120a(2). By causing the second portion of the access network 115(2) to accept the call 145 with the indication of priority 155 being substantially the same as the granted priority level 165, as the arrow 430 shows, the application server 175 may indicate a floor grant with the indication of priority 155 based on the granted priority level 165 to the first portion of the access network 115(1), in arrow 435.

In response to the floor grant, as indicated by the arrow 440, the first portion of the access network 115(1) may allocate a resource based on the granted priority level 165 of the targeted access terminal 120a(2) to enable flow of one or more messages or traffic being sent from the targeted access terminal 120a(2) back to the call initiating access terminal 120a(1). The first portion of the access network 115(1) may control an admission control parameter, an overload control parameter and/or a resource allocation parameter based on the indication of priority 155 to meet a desired Grade of Service (GoS) of the call initiating access terminal 120a(1).

One more embodiments of the techniques described above may have the number of advantages over conventional practice. Determining whether or not to admit a requested call session based upon Grade of Service (GoS) requirements may allow a wireless communication system to ensure that the highest grade of service is provided to premium users. For example, the Grade of Service (GoS) requirements of different users may allocate available system resources to ensure that the highest grade of service is provided to premium users. By allowing each access terminal 120 to access the access network 115 on a per user/call flow basis, variable Grade of Service (GoS) may be supported more efficiently.

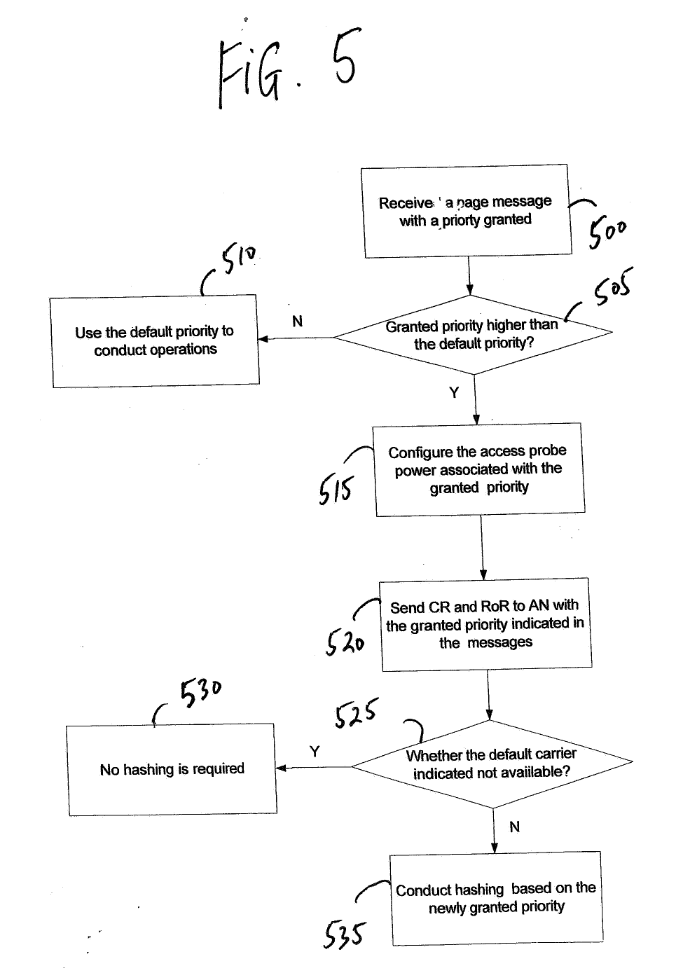

FIG. 5 conceptually illustrates one exemplary embodiment of a method of accessing the access network 115 for a call initiating user at the call initiating access terminal 120a(1) in the Internet Protocol (IP)-based network 105 to support the desired Grade of Service (GoS), in accordance with the present invention. In response to determining granting of a new priority to the targeted access terminal 120a(2) different than an original priority therewith, the second client application 130(2) may reconfigure the targeted access terminal 120a(2) based on the new priority granted. That is, the second client application 130(2) may configure the targeted access terminal 120a(2) to perform a hashing, access, and/or connection request functions based on the newly granted priority.

At block 500, upon receiving a page response with a priority granted at the targeted access terminal 120a(2), the second client application 130(2) may check whether the granted priority is higher than the default priority, at a decision block 505. If the newly granted priority level is same or lower than the default priority level, the second client application 130(2) may use the default priority to perform a hashing, access, and/or connection request functions, as shown in block 510. Conversely, if the newly granted priority level is higher than the default priority level, at block 515, the second client application 130(2) may configure the access probe power associated with the granted priority.

At block 520, the targeted access terminal 120a(2) may send the CR and/or the RoR message(s) to the second portion of the access network 115(2) with the granted priority indicated in the messages. At a decision block 525, the second client application 130(2) may determine whether a default carrier indicated not available. That is, the second client application 130(2) may determine whether the default carrier is busy for a particular priority class associated with the targeted access terminal 120a(2) being paged and granted the new priority for hashing based on the new priority. If indicated yes in the decision block 525, at block 530, the second client application 130(2) determines that no hashing is desired or required. Otherwise, at block 535, the second client application 130(2) may perform hashing based on the newly granted priority. In this manner, the targeted access terminal 120a(2) may perform hashing based on a different priority level or class of one or more priority levels and classes defined by the first and second priority level and priority class data 150(1,2).

By handling call session requests based on a Grade of Service (GoS), in the illustrated embodiment, a request for a new call connection or a pending reservation with a high-grade of service flow may be provided access to the access network 115. The access network 115 may determine whether a call flow associated with the new call connection or the pending reservation is a high-grade of service flow or a low grade of service flow. If the call flow is a relatively high grade of service flow, then the new call connection or pending reservation may be allocated system resources so that the high grade of service flow with its QoS is ensured since the call flow is a relatively high grade of service flow. In one embodiment, the high grade of service flow may have to be admitted at the expense of the QoS of the low grade of service users or flows when the system is heavily loaded or even overloaded. In the illustrated embodiment, accordingly, a new call connection or pending reservation with high grade of service, such as an emergency call and/or high premium services, may be ensured a desired GoS.

In one embodiment, by using of the wireless communication system 100, a high-speed wireless data network may wirelessly communicate mobile data at a speed and coverage desired by individual users or enterprises. According to one embodiment, the high-speed wireless data network may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of accessing an access network to call at least one target access terminal on a wireless network, the method comprising:
associating an indication of priority with a call at a source access terminal that initiates said call; and
sending said indication of priority to a first portion of said access network for providing an indication of priority grant at said at least one target access terminal for said call.

2. A method, as set forth in claim 1, wherein providing an indication of priority grant further comprises:
enabling a desired Grade of Service for at least one user associated with said at least one target access terminal by granting substantially the same said priority of a caller to said call.

3. A method, as set forth in claim 1, wherein providing an indication of priority grant further comprises:
enabling a desired Grade of Service for a group of users associated with said at least one target access terminal by granting substantially the same said priority of a caller to said call.

4. A method, as set forth in claim 1, wherein sending said indication of priority to said access network further comprises:
indicating a priority level for said call to support an end-to-end service based on a desired Grade of Service for at least one user of said at least one target access terminal.

5. A method, as set forth in claim 1, wherein sending said indication of priority to said first portion of said access network further comprises:
indicating a priority level for a flow request to support an end-to-end service based on a desired Grade of Service for at least one user of said at least one target access terminal.

6. A method, as set forth in claim 1, further comprising:
issuing at least one of a connection request message and an application flow reservation request message with said indication of priority for said call on an air interface link to said first portion of said access network.

7. A method, as set forth in claim 2, further comprising:
causing said first portion of said access network to bind a request for initiating said call with said indication of priority associated with said call at said source access terminal.

8. A method, as set forth in claim 7, wherein causing said first portion of said access network to bind a request for initiating said call with said indication of priority further comprises:
causing an application server associated with a call network to announce binding of said request for initiating said call with said indication of priority to said second portion of said access network coupled to said at least one target access terminal.

9. A method, as set forth in claim 8, further comprising:
in response to said binding of said request for initiating said call with said indication of priority, causing said second portion of said access network to page said at least one target access terminal with said indication of priority grant; and
granting a call priority to said at least one target access terminal based on said indication of priority grant for completing said call, wherein said call priority being substantially the same as said priority of said indication of priority.

10. A method, as set forth in claim 9, further comprising:
in response to granting of said call priority to said at least one target access terminal, causing said at least one target access terminal to configure based on a granted priority having substantially the same said priority of said call and issue a connection request and an application flow reservation request to said second portion of said access network coupled to said at least one target access terminal.

11. A method, as set forth in claim 10, further comprising:
enabling said second portion of said access network to at least one of admit said call, provide an overload control and allocate a resource based on said granted priority of said at least one target access terminal.

12. A method, as set forth in claim 11, further comprising:
causing said second portion of said access network to accept said call with said indication of priority being substantially the same as said granted priority;
causing said application server to indicate a floor grant with said indication of priority based on said granted priority to said first portion of said access network; and
causing said first portion of said access network to allocate a resource based on said granted priority of said at least one target access terminal to enable flow of one or more messages or traffic being sent from said at least one target access terminal back to said source access terminal.

13. A method, as set forth in claim 5, further comprising:
providing at least one of an access probe power setting, hashing and said indication of priority to support said desired Grade of Service of a different priority class of one or more priority classes associated with said at least one user of said at least one target access terminal.

14. A method, as set forth in claim 8, further comprising:
in response to said binding of said request for initiating said call with said indication of priority, causing said second portion of said access network to page more than one users than said at least one user associated with said at least one target access terminal to multicast said indication of priority grant; and
granting a high priority to said more than one users based on said indication of priority grant for responding to a priority call, wherein said high priority being substantially the same as said priority of said indication of priority.

15. A method, as set forth in claim 1, further comprising:
causing said first portion of said access network to control at least one of an admission control parameter, an overload control parameter and a resource allocation parameter based on the priority indication of said source access terminal to meet a desired Grade of Service of said source access terminal.

16. A method of controlling a call flow from a call initiating access terminal to a target access terminal in an Internet Protocol (IP)-based network of first and second portions of an access network, the method comprising:
receiving a message including a call priority associated with an incoming call at said first portion of said access network coupled to said call initiating access terminal; and
enabling said second portion of said access network coupled to said target access terminal to grant a priority indication substantially the same as said call priority of said incoming call.

17. A method, as set forth claim 16, further comprising:
using an application server associated with said IP-based network to pass said priority indication to said second portion of said access network for further paging said grant of said priority indication to said target access terminal.

18. A method, as set forth claim 17, further comprising:
enabling a desired Grade of Service for at least one user associated with said target access terminal by granting substantially the same said priority of a call initiator to said incoming call.

19. A method, as set forth claim 17, further comprising:
receiving a priority level for said incoming call to support an end-to-end service based on a desired Grade of Service with an associated Quality of Service for said at least one user of said target access terminal.

20. A method, as set forth claim 17, further comprising:
receiving said message including at least one of a connection request message and an application flow reservation request message at said first portion of said access network on an air interface with said call priority associated with said incoming call; and
in response to granting of said call priority to said target access terminal, causing said target access terminal to configure based on a granted priority having substantially the same said call priority of said incoming call.

21. A method, as set forth claim 20, further comprising:
causing said first portion of said access network to send a multicast message to indicate an alert mode to a group of users at an associated set of access terminals which are currently in a normal mode that indicates an idle state; and
in response to said multicast message, enabling at least one of waking-up of said associated set of access terminals more often than in a non-alert mode, sending of a message for a route update more often, and boosting a level of pilot power to another level.

22. A method of accessing an access network for a call initiating user at an access terminal in an Internet Protocol (IP)-based network, the method comprising:
in response to determining granting of a new priority to said access terminal different than an original priority associated with said access terminal, reconfiguring said access terminal based on said new priority granted to configure said access terminal to perform at least one of a hashing, access, and connection request functions based on the granted said new priority.

23. A method, as set forth claim 22, further comprising:
defining one or more priority levels based on a type of at least one of call or flow for providing a priority access and call admission to said call in an access network;
defining one or more priority classes for said one or more priority levels to support a desired Grade of Service with a Quality of Service; and
using different power ramps and back-off functions with different initial and ending access probe power level corresponding to a different priority level or class of said one or more priority levels and classes.

24. A method, as set forth claim 23, further comprising:
causing said access terminal to perform hashing based on said different priority level or class of said one or more priority levels and classes.

25. A method, as set forth claim 23, further comprising:
causing said access terminal to use hashing based on said new priority.

26. A method, as set forth claim 25, further comprising:
determining whether a default carrier is busy for a priority class associated with said access terminal being paged and granted said new priority for hashing based on said new priority.
